(19) United States
(12) Patent Application Publication
(10) Pub. No.: US 2014/0178780 A1
(43) Pub. Date: Jun. 26, 2014

(54) WATER ACTIVATED INSTANT HYDROGEN GENERATOR WITH PASSIVE CONTROL ON HYDROGEN DEMAND

(71) Applicant: U.S. ARMY RESEARCH LABORATORY ATTN; RDRL-LOC-1, (US)

(72) Inventor: Xiaoming Ren, Adelphi, MD (US)

(73) Assignee: U.S. ARMY RESEARCH LABORATORY ATTN: RDRL-LOC-I, Adelphi, MD (US)

(21) Appl. No.: 13/723,389

(22) Filed: Dec. 21, 2012

(51) Int. Cl. C01B 3/06; H01M 8/06

(52) U.S. Cl. CPC C01B 3/065; H01M 8/0606
USPC 429/416; 422/162

(57) ABSTRACT

Apparatus for generating hydrogen gas are provided herein. In some embodiments, an apparatus for generating hydrogen gas may include a first chamber; a first mixture comprising a chemical hydride and a catalyst disposed within the first chamber; a second chamber coupled to the first chamber; a connector; a third chamber coupled by the connector to the second chamber, wherein the third chamber is fluidly coupled to the first chamber; a sealing element coupled to at least one of the second chamber or the third chamber; an outlet fluidly coupled to the first chamber; and a resilient member disposed within the third chamber and configured to control the flow of water into the first chamber via movement of the resilient member in response to hydrogen gas pressure within the apparatus.

### GOVERNMENT INTEREST

Governmental Interest—The invention described herein may be manufactured, used, sold, imported and licensed by or for the U.S. Government.

### FIELD OF INVENTION

Embodiments of the present invention generally relate to hydrogen gas generation, more particularly, to an apparatus for generating hydrogen gas.

### BACKGROUND OF THE INVENTION

With the recent increase in portable electronics, there is an increasing demand on the electric power for such portable electronic devices. Fuel cell technologies have frequently been used to fulfill the high energy density requirements which current battery technologies are unable to meet. For example, a direct methanol fuel cell (DMFC) is a popular fuel cell technology for portable power applications. However, the DMFC is ill-suited as a wearable power source because it suffers from several problems, such as requiring an active battery for start-up, poor reliability and complicated system control, and low fuel to electric energy conversion efficiency. In comparison, hydrogen is an ideal fuel for a polymer electrolyte membrane fuel cell (PEMFC), without the problems associated with the DMFC.

One of the biggest challenges for a PEMFC for wearable power applications is a suitable travel-convenient hydrogen source. For example, hydrogen gas stored in a highly compressed gas cylinder at a pressure of 5,000 psig only contains 23 grams of hydrogen/liter, or less than 2% by weight of the hydrogen storage system. In addition, such a system presents a safety risk to the user due to the close proximity of compressed gas. Alternatively, hydrogen can be produced from metal hydrides by thermal decomposition. However, this process requires a hot heat source (e.g. greater than 125 degrees Celsius) which can only be supplied using valuable electric power with careful control.

Therefore, the inventors have provided an improved apparatus for generating hydrogen gas.

### BRIEF SUMMARY OF THE INVENTION

Embodiments of the present invention relate to an apparatus for generating hydrogen gas which may include a first chamber; a first mixture comprising a chemical hydride and a catalyst disposed within the first chamber; a second chamber coupled to the first chamber; a connector; a third chamber coupled by the connector to the second chamber, wherein the third chamber is fluidly coupled to the first chamber; a sealing element coupled to at least one of the second chamber or the third chamber; an outlet fluidly coupled to the first chamber; and a resilient member disposed within the third chamber and configured to control the flow of water into the first chamber via movement of the resilient member in response to hydrogen gas pressure within the apparatus.

In some embodiments, a wearable power unit may include a fuel cell; a belt attached to the fuel cell; and a hydrogen gas generating apparatus coupled to the fuel cell, comprising: a first chamber comprising a first surface coupled to a plurality of sidewalls, a rigid porous member disposed opposite the first surface and coupled to the plurality of sidewalls, a first filter coupled to the rigid porous member, and a first volume defined by the first surface, the plurality of sidewalls and the rigid porous member; a first mixture comprising a chemical hydride and a catalyst disposed within the first volume of the first chamber; an outlet fluidly coupled to the first chamber; a second chamber comprising a first surface coupled to a plurality of sidewalls, wherein the outlet is coupled to the first surface, a second volume defined by the first surface and the plurality of sidewalls, wherein the first chamber is coupled within the second volume, and a second filter disposed between the outlet and the first chamber; a connector; a third chamber comprising a third volume defined by a first surface and a plurality of sidewalls, wherein the third chamber is coupled by the connector to the second chamber, and wherein the third chamber is fluidly coupled to the first chamber, and wherein the third chamber is configured to hold water; a sealing element coupled to at least one of the second chamber or the third chamber; and a resilient member coupled to the first surface of the third volume of the third chamber and configured to control the flow of water into the first chamber via movement of the resilient member in response to hydrogen gas pressure within the apparatus.

Other and further embodiments of the invention are described in more detail, below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic diagram of the assembly of a hydrogen gas generating apparatus in accordance with some embodiments of the present invention.

FIG. 2 depicts a schematic diagram of a first chamber coupled to a second chamber in accordance with some embodiments of the present invention.

FIG. 3 depicts a schematic diagram of a third chamber in accordance with some embodiments of the present invention.

FIGS. 4A-C depict a hydrogen gas generating apparatus in varying stages of use in accordance with some embodiments of the present invention.

FIG. 5 depicts a schematic diagram of a power source comprising a hydrogen generating apparatus coupled to a fuel cell array in accordance with some embodiments of the present invention.

### DETAILED DESCRIPTION OF THE INVENTION

Embodiments of the present invention include a hydrogen gas generating apparatus. The hydrogen gas generating apparatus in accordance with embodiments of the present invention advantageously comprises separate components that can be easily transported and quickly assembled for use with any available water source, such as sea water, snow, drinking water, waste water, and urine. Separate components also help to maintain a long shelf-life by preventing the accidental formation of hydrogen gas. Upon assembly, the hydrogen gas generating apparatus immediately begins generating hydrogen gas with passive control of the hydrogen generation rate. The apparatus also advantageously provides passive control of hydrogen gas generation regardless of the orientation of the apparatus.

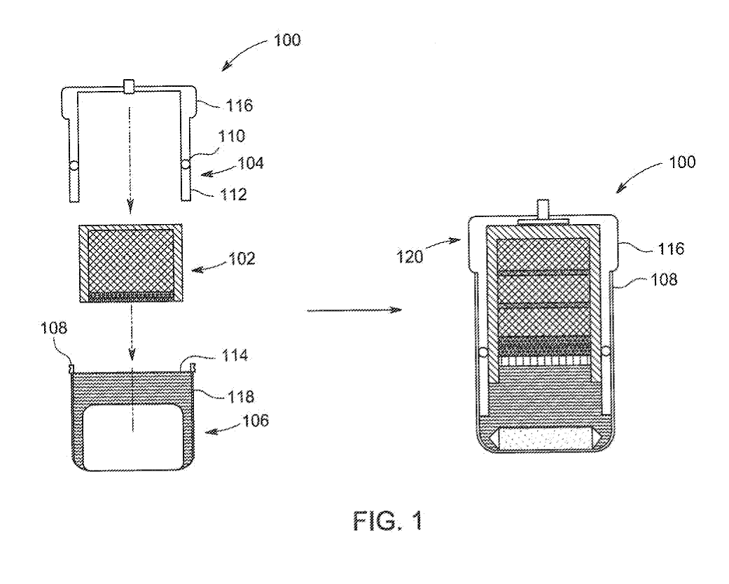

FIG. 1 depicts a schematic diagram of the assembly of a hydrogen gas generating apparatus 100 (hereinafter, the apparatus 100) in accordance with some embodiments of the present invention. The apparatus 100 generally comprises a first chamber 102, a second chamber 104, and a third chamber 106. A first mixture comprising a chemical hydride and a catalyst is disposed within the first chamber 102. The third chamber 106 is configured to hold water. The second chamber 104 is coupled to the first chamber. The third chamber 106 is coupled by a connector to the second chamber and is fluidly coupled to the first chamber 102.

The reaction of the first mixture with water forms hydrogen gas. In some embodiments, the chemical hydride is a metal hydride (e.g. MgH₂, NaAlH₄, Na₃AlH₆) a metal borohydride (e.g. LiBH₄, NaBH₄, Mg(BH₄)₂, Be(BH₄)₂), or a metal silicide (e.g. NaSi, Na₂Si, Na₃Si, LiSi, Li₂Si, Li₃Si, MgSi, Mg₂Si, Ca₂Si, CaSi₂), or the like.

In some embodiments, the catalyst is at least one of a cobalt powder catalyst (e.g. CoCl₂, CoO, Co₂B), a ruthenium powder catalyst (e.g. RuCl₃, Ru₂O₃), a manganese powder catalyst (e.g. MnCl₂, MnO₂), an iron powder catalyst (e.g. FeCl₂), a nickel powder catalyst (e.g. NiCl₂), an aluminum powder catalyst (e.g. Al₂O₃), a sodium aluminosilicate powder catalyst (e.g. NaAlSiO₄, a platinum powder catalyst (e.g. platinum black or platinum on a support material, such as carbon or alumina), or a silver powder catalyst (e.g. silver powder or silver on a support material, such as carbon or alumina) or the like. Addition of the catalyst advantageously increases the rate of reaction between the chemical hydride and water.

In some embodiments, the fiat chamber 102 is permanently coupled to the second chamber 104. Once the first mixture is completely reacted with the water, the coupled chambers 102, 104 can be discarded and replaced with a fresh unit to easily continue hydrogen gas production. In some embodiments, the first chamber 102 is detachable from the second chamber 104. In such embodiments, once the first mixture is completely reacted with the water, the first chamber 102 can be discarded and replaced with a fresh unit. A detachable second chamber 104 advantageously minimizes the size and weight of the disposable component.

A connector 120 is configured to couple the second chamber 104 to the third chamber 106. When the second chamber 104 is coupled to the third chamber 106. the third chamber 106 and the first chamber 102 are fluidly coupled. In some embodiments, the connector 120 is a latch. For example, as shown in FIG. 1, recessed surfaces 108 are provided on the outer surface 118 of the third chamber 106 that latch with corresponding tabs 116 on the outer surface 112 of the second chamber 104, preventing the second chamber 104 and the third chamber 106 from readily coming apart. The tabs 116 can be configured to release simply by the use of sufficient force. In some embodiments, the connector 120 comprises complimentary threads disposed in the second chamber 104 and the third chamber 106 that facilitate control of the coupling of the second chamber 104 with the third chamber 106 via a screwing motion.

A sealing element 110 is coupled to at least one of the second chamber 104 or the third chamber 108 and is configured to maintain a watertight seal between the coupled chambers 104, 106. In some embodiments, the second chamber 104 may include an outer surface 112 having a sealing element 110 (for example, a gasket), for example, lodged in an annular groove formed in the outer surface 112 of the second chamber 104. When the second chamber 104 and the third chamber 106 are coupled together, the sealing element 110 provides a substantially watertight seal between the outer surface 112 of the second chamber 104 and the inner surface 114 of the third chamber 106. In some embodiments, the third chamber 106 may include an inner surface 114 having a sealing element lodged in an annular groove formed in the inner surface 114 of the third chamber 106.

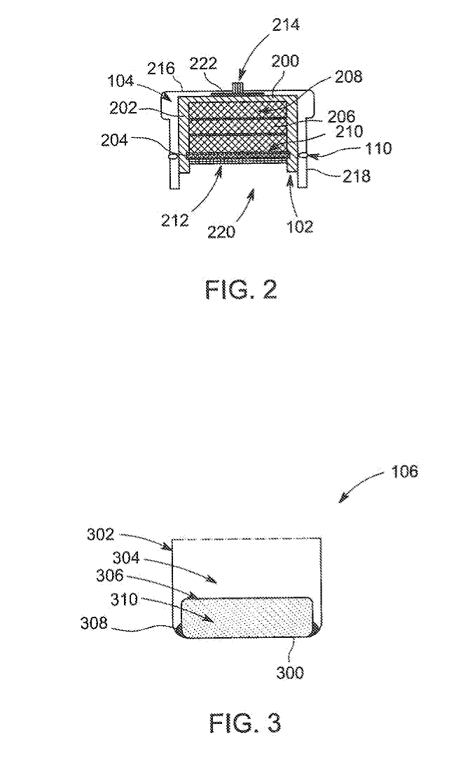

FIG. 2 depicts a schematic diagram of the first chamber 102 coupled to the second chamber 104 in accordance with some embodiments of the present invention. The first chamber 102 comprises a first surface 200 coupled to a plurality of sidewalls 202, wherein the first surface 200 and the plurality of sidewalls 202 are comprised of a porous hydrophobic material. The use of a porous hydrophobic material advantageously permits easy permeation of hydrogen gas while preventing the penetration of water. In some embodiments, the porous hydrophobic material may be polytetrafluoroethylene (PTFE), porous polypropylene, or the like. In some embodiments, the first chamber 102 comprises a plurality of channels within the first surface 200 and the plurality of sidewalls 202 directing hydrogen gas formed within the first chamber 102 to the outlet 214.

The first chamber 102 also comprises a rigid porous member 204 disposed opposite the first surface 200 and coupled to the plurality of sidewalls 202. In some embodiments, the rigid porous member 204 is a glass, ceramic, metal or plastic plate. The rigid porous member 204 advantageously permits the flow of water and hydrogen gas to and from the first volume 206 while holding the first mixture within the first volume 206.

The first surface 200, the plurality of sidewalls 202 and the rigid porous member 204 define a first volume 206. The first mixture is disposed within the first volume 206. In some embodiments, the first volume 206 contains alternating layers of chemical hydride 208 and catalyst 210. In some embodiments, the chemical hydride 208 and the catalyst 210 are intermixed or in pellets.

A first filter 212 is coupled to the rigid porous member 204 to prevent particulate contamination that may be present in water from entering the first volume 206 and to prevent clogging of the rigid porous member 204.

The second chamber 104 comprises a first surface 216 coupled to a plurality of sidewalls 218. In some embodiments, the outlet 214 is coupled to the first surface 216 of the second chamber 104. The outlet 214 is fluidly coupled to the first chamber 102 and configured to release hydrogen gas formed within the apparatus 100 by the reaction of the chemical hydride and the catalyst with water. The first surface 216 and the plurality of sidewalls 218 define a second volume 220. The first chamber 102 is retained within the second volume 220.

In some embodiments, the first surface 216 and the plurality of sidewalls 218 of the second chamber 104 are made of an impermeable material such as ceramics, plastic or metal. In some embodiments, a second filter 222 is disposed between the outlet 214 and the first chamber 102. In embodiments where the water source contains urine, the second filter 222 will trap any ammonia formed during the reaction with the chemical hydride 208. The second filter 222 contains non-evaporating acid, such as phosphoric acid, absorbed in porous carbon or zeolite materials, in order to trap ammonia.

FIG. 3 depicts a schematic diagram of the third chamber 106 in accordance with some embodiments of the present invention. The third chamber 106 comprises a first surface 300 coupled to a plurality of sidewalls 302. A third volume 304 is defined by the first surface 300 and the plurality of sidewalls 302.

A resilient member 306 is disposed within the third chamber 106 and configured to control the flow of water into the first chamber 102 via movement of the resilient member 306 in response to a hydrogen gas pressure within the apparatus 100. In some embodiments, the resilient member 306 is coupled to the first surface 300 of the third chamber 106. In some embodiments, the resilient member 306 is coupled to the first surface 300 of the third chamber 106 by any suitable attachment 308, such as gluing, bonding, press-fit, or the like. In some embodiments, as shown in FIG. 3, the resilient member 306 is a bladder inflated with any suitable gas 310, such as air, nitrogen, or hydrocarbon gases. In some embodiments, the resilient member 306 is a piston coupled to the first surface of third chamber by one or more springs.

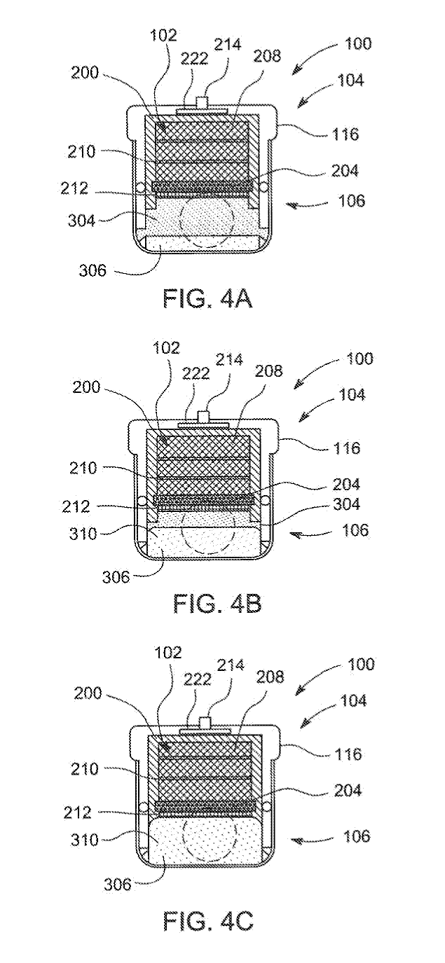

FIGS. 4A-4C depict an assembled apparatus 100 in various stages of use, in accordance with some embodiments of the present invention. In FIG. 4A, the first chamber 102 is retained within the second chamber 104, which is coupled to the third chamber 106 via tabs 116 latched to recessed surfaces 108. The pressure created within the apparatus 100 from coupling the second chamber 104 and the third chamber 106 fully compresses the resilient member 306. The coupling of the second chamber 104 and the third chamber 106 also pushes the water from the third volume 304 past the first filter 212, through the rigid porous member 204, and into contact with the first mixture where the reaction of the chemical hydride 208, the catalyst 210, and the water form hydrogen gas. The hydrogen gas permeates through the layers of the first mixture, through the porous hydrophobic first surface 200, and through the second filter 222 to the outlet 214. In embodiments, where the outlet 214 is closed before hydrogen gas is released for usage, the excess hydrogen gas builds up within the apparatus 100. The build-up of hydrogen gas pressure prevents the compressed resilient member 306 from expanding and forcing additional water into the first volume 206. Consequently, the production of hydrogen gas ceases.

As shown In FIG. 4B, the outlet 214 can be opened to allow the hydrogen gas to flow out of the apparatus 100. The outflow of hydrogen gas reduces the pressure in the apparatus 100, allowing the gas 310 to expand the resilient member 306 and force water to enter the first volume 206 thereby producing additional hydrogen gas. As the hydrogen gas continues to flow from the outlet 214, the resilient member 306 continues to expand, as depicted in FIG. 4C, until it fills the third volume 304, thereby forcing all the water from the third volume 306 into the first volume 206. In some embodiments, the sidewalls of 302 of the third chamber 106, or at least portions thereof, may be transparent to provide a visual indication of the expansion of the resilient member 306 and the amount of water left in the third volume 304. In some embodiments, the sidewalls 302 of the third chamber 306 comprise at least one window to allow a visual indication of the expansion of the resilient member 306 and the amount of water left in the third volume 304.

In some embodiments, the first chamber 102, second chamber 104, and third chamber 108 are sized to optimize efficiency. Specifically, the third chamber 106 is sized to hold sufficient water to use up all of the first mixture. The amount of water needed to use up all of the first mixture depends on the chemical reactions of the metal hydride used and on the operating condition, such as the type of catalyst, the amount of catalyst, and the reaction temperature and pressure in the hydrogen gas generating apparatus 100. For example, to consume the maximum amount of sodium borohydride with a minimum amount of water, the volume ratio of the water to the sodium borohydride ranges from about 1.3 to about 3.8 at ambient temperature. For other chemical hydrides used to generate hydrogen, the volume ratio of water to chemical hydride may be calculated from the stoichiometric ratio of the chemical reaction and the density of the chemical hydride, which falls within the range of about 0.8 to about 3.8.

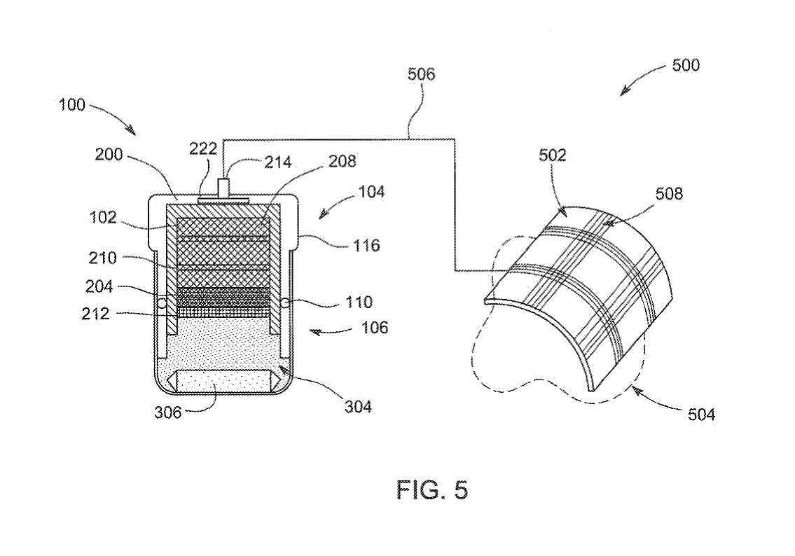

FIG. 5 shows a schematic diagram of a power unit 500 comprising a hydrogen generating apparatus 100 as described above coupled to a fuel cell array, such as a polymer electrolyte membrane fuel cell (PEMFC) array 502. Although illustratively described herein in connection with a PEMFC array, the fuel cell array may also be other types of fuel cells, such as a solid oxide fuel cell, a phosphoric acid fuel cell, a high temperature polybenzimidazole (PBI) membrane fuel cell, or the like. In some embodiments, the apparatus 100 is coupled to a passively operated air-breathing PEMFC array 502 having a belt 504 for wearable power applications. The power unit 500 is suitable as wearable power generation to power portable electronics. The power unit 500 is advantageously operated with no moving parts for electric power generation at ambient temperature. The power unit 500 operates in a stand-alone capacity, without the need for start-up assistance from a functional battery. The power unit also provides a high surface area for heat dissipation which reduces surface temperatures and thermal signature. The hydrogen generating apparatus 100 used in connection with the PEMFC array 502 is advantageous for portable applications due to the low operating temperature.

The apparatus 100. as described above, advantageously provides hydrogen gas to the PEMFC array 502 on an as-needed basis in a travel-convenient package. The apparatus 100 provides hydrogen gas to the PEMFC array 502 via feed line 506. In some embodiments, the PEMFC array 502 may be an air-breathing fuel cell array. In some embodiments, the apparatus 100 produces a small amount of water vapor along with the hydrogen. The PEMFC array 502 with the hydrogen fuel feed at the anode achieves efficient water removal from anode channels 508 without intermittent anode gas ventilation, thereby achieving high hydrogen fuel utilization efficiency. Excess water is conveniently evaporated from the PEMFC array 502 surface.

While the foregoing is directed to embodiments of the present invention, other and further embodiments of the invention may be devised without departing from the basic scope thereof.

1. A hydrogen gas generating apparatus, comprising:
a first chamber;
a first mixture comprising a chemical hydride and a catalyst disposed within the first chamber;
a second chamber coupled to the first chamber;
a connector;
a third chamber coupled by the connector to the second chamber, wherein the third chamber is fluidly coupled to the first chamber;
a sealing element coupled to at least one of the second chamber or the third chamber;
an outlet fluidly coupled to the first chamber; and
a resilient member disposed within the third chamber and configured to control the flow of water into the first chamber via movement of the resilient member in response to hydrogen gas pressure within the apparatus.

2. The apparatus of claim 1, wherein the first chamber is detachable from the second chamber.

3. The apparatus of claim 1, wherein the second chamber is detachable from the third chamber.

4. The apparatus of claim 1, wherein the chemical hydride is at least one of a metal hydride, a metal borohydride, or a metal suicide.

5. The apparatus of claim 1. wherein the catalyst is at least one of a cobalt powder catalyst, a ruthenium powder catalyst, a manganese powder catalyst, an iron powder catalyst, a nickel powder catalyst, an aluminum powder catalyst, a sodium aluminosilicate powder catalyst, a platinum powder catalyst, or a silver powder catalyst.

6. The apparatus of claim 1, wherein the first chamber comprises:
a first surface coupled to a plurality of sidewalls, wherein the first surface and the plurality of sidewalls are comprised of a porous hydrophobic material;
a rigid porous member disposed opposite the first surface and coupled to the plurality of sidewalls;
a first volume defined by the first surface, the plurality of sidewalls and the rigid porous member, wherein the first volume comprises the first mixture therein; and
a first filter coupled to the rigid porous member.

7. The apparatus of claim 6, wherein the first chamber comprises a plurality of channels within the first surface and the plurality of sidewalls directing hydrogen gas formed within the first chamber to the outlet.

8. The apparatus of claim 1, wherein the second chamber comprises:
a first surface coupled to a plurality of sidewalls, wherein the outlet is coupled to the first surface;
a second volume defined by the first surface and the plurality of sidewalls, wherein the second volume retains the first chamber; and
a second filter disposed between the outlet and the first chamber.

9. The apparatus of claim wherein the third chamber comprises:
a first surface coupled to a plurality of sidewalls, wherein the resilient member is coupled to the first surface; and
a third volume defined by the first surface and the plurality of sidewalls, wherein the third volume is configured to hold water.

10. The apparatus of claim 9, wherein the plurality of sidewalls are configured to allow a visual indication of the water level in the third chamber.

11. The apparatus of claim 10, wherein the plurality of sidewalls are transparent.

12. The apparatus of claim 1, wherein the resilient member is an inflated bladder.

13. The apparatus of claim 1, wherein the resilient member is a piston coupled to the third chamber by one or more springs.

14. The apparatus of claim 1, wherein the connects r comprises a latch.

15. The apparatus of claim 1, wherein the connector comprises complimentary threads disposed in the second chamber and the third chamber that facilitate control of the coupling of the second chamber with the third chamber via a screwing motion.

16. The apparatus of claim wherein the sealing element comprises a gasket.

17. The apparatus of claim 1, wherein the first chamber and the second chamber are configured to react all the water in the third chamber with all of the first mixture in the first chamber.

18. The apparatus of claim 17, wherein the volume ratio of water to a first mixture ranges from about 0.8 to about 3.8.

19. The apparatus of claim 1, her comprising a fuel cell coupled to the outlet.

20. A wearable power unit, comprising:
a fuel cell;
a belt attached to the fuel cell; and
a hydrogen gas generating apparatus coupled to the fuel cell, comprising:
a first chamber comprising a first surface coupled to a plurality of sidewalls, a rigid porous member disposed opposite the first surface and coupled to the plurality of sidewalls, a first filter coupled to the rigid porous member, and a first volume defined by the first surface, the plurality of sidewalls and the rigid porous member;
a first mixture comprising a chemical hydride and a catalyst disposed within the first volume of the first chamber;
an outlet fluidly coupled to the first chamber;
a second chamber comprising a first surface coupled to a plurality of sidewalls, wherein the outlet is coupled to the first surface, a second volume defined by the first surface and the plurality of sidewalls, wherein the first chamber is coupled within the second volume, and a second filter disposed between the outlet and the first chamber;
a connector;
a third chamber comprising a third volume defined by a first surface and a plurality of sidewalls, wherein the third chamber is coupled by the connector to the second chamber, and wherein the third chamber is fluidly coupled to the first chamber, and wherein the third chamber is configured to hold water;
a sealing element coupled to at least one of the second chamber or the third chamber; and
a resilient member coupled to the first surface of the third volume of the third chamber and configured to control the flow of water into the first chamber via movement of the resilient member in response to hydrogen gas pressure within the apparatus.
